(19) United States
(12) Patent Application Publication
(10) Pub. No.: US 2010/0083110 A1
(43) Pub. Date: Apr. 1, 2010

(54) HUMAN-MACHINE INTERFACE HAVING MULTIPLE TOUCH DISPLAY NAVIGATION CAPABILITIES

(76) Inventors: Steven J. Scott, Ocononowoc, WI (US); Thong T. Nguyen, Anaheim, CA (US); Greggory Cieslak, Greendale, WI (US); Thomas Lloyd Heidebrecht, Cambridge, WI (US); Pete J. Klein, Kenosha, WI (US); Gary Dan Dotson, Muskego, WI (US)

Correspondence Address: ROCKWELL AUTOMATION, INC/SR, 1201 SOUTH SECOND STREET, MAIL STOP E-F719, MILWAUKEE, WI, 53204, US

(21) Appl. No.: 12/242,445

(22) Filed: Sep. 30, 2008

(51) Int. Cl. G06F 3/041

(52) U.S. Cl. 715/702

(57) ABSTRACT

A Human-Machine Interface (HMI) system comprises a user interface and a processing system. The user interface displays a plurality of machine systems in an automation environment having a plurality of automation information, displays an information menu indicating a plurality of information types associated with the plurality of machine systems, receives a first touch on a surface of the user interface selecting an information type from the plurality of information types, and, while receiving the first touch, receives a second touch on the surface of the user interface selecting a machine system from the plurality of machine systems. The processing system processes the first touch and the second touch to select from the plurality of automation information an automation information associated with the selected information type and the selected machine system. The user interface displays the selected automation information.

### TECHNICAL FIELD

The invention is related to the field of human-machine interfaces, and in particular, to a method and system for navigating a human-machine interface.

### TECHNICAL BACKGROUND

Industrial environments include automobile manufacturing factories, food processing plants, and microprocessor fabrication facilities. The typical industrial environment includes various machines, such as pumps, motors, and robots. These machines continually produce data that indicates the current status of the machines, such as the machine's pressure, temperature, or speed.

The typical industrial environment also includes a Human-Machine Interface (HMI). The HMI receives and processes the status data from the machines to generate various graphical displays. The graphical displays indicate the current and historical status of the machines. For example, an HMI graphical display might indicate the pressure of a pump, the speed of a motor, or the output of a robot. The HMI may also control the machines. For example, the HMI might turn on a pump, speed-up a motor, or stop a robot.

The HMI may present various information in textual and graphical displays. Unfortunately, the user must operate traditional input devices such as a keyboard and mouse to navigate within the many displays. This method of display navigation may be too slow, inefficient, or cumbersome for some users.

### TECHNICAL SUMMARY

A Human-Machine Interface (HMI) system comprises a user interface and a processing system. The user interface displays a plurality of machine systems in an automation environment having a plurality of automation information, displays an information menu indicating a plurality of information types associated with the plurality of machine systems, receives a first touch on a surface of the user interface selecting an information type from the plurality of information types, and, while receiving the first touch, receives a second touch on the surface of the user interface selecting a machine system from the plurality of machine systems. The processing system processes the first touch and the second touch to select from the plurality of automation information an automation information associated with the selected information type and the selected machine system. The user interface displays the selected automation information.

In some examples, the plurality of machine systems comprise at least one machine and at least one control system configured to control the at least one machine.

In some examples, the at least one control system includes operation code to operate the at least one machine.

In some examples, the information type comprises maintenance information.

In some examples, the information type comprises performance information.

In some examples, the information type comprises historical information.

In some examples, the information type comprises an operating status associated with the selected machine system.

In some examples, the information type comprises a geographic location associated with the selected machine system.

In some examples, the information type comprises other machine systems connected to the selected machine system.

Also disclosed herein is a method of operating a Human-Machine Interface (HMI) system wherein the method comprises displaying on a user interface a plurality of machine systems in an automation environment having a plurality of automation information, displaying an information menu on the user interface indicating a plurality of information types associated with the plurality of machine systems, receiving a first touch on a surface of the user interface selecting an information type from the plurality of information types, while receiving the first touch, receiving a second touch on the surface of the user interface selecting a machine system from the plurality of machine systems, processing the first touch and the second touch to select from the plurality of automation information an automation information associated with the selected information type and the selected machine system, and displaying the selected automation information.

Also disclosed herein is a software product configured to operate a Human-Machine Interface (HMI) system. The software product comprises HMI operation software, HMI interface software, and a storage system that stores the HMI operation software and the HMI interface software. The HMI interface software is configured to direct a user interface to display a plurality of machine systems in an automation environment having a plurality of automation information, display an information menu indicating a plurality of information types associated with the plurality of machine systems, receive a first touch on a surface of the user interface selecting an information type from the plurality of information types, and, while receiving the first touch, receive a second touch on the surface of the user interface selecting a machine system from the plurality of machine systems. The HMI operation software is configured to direct a processing system to process the first touch and the second touch to select from the plurality of automation information an automation information associated with the selected information type and the selected machine system. The HMI interface software is configured to direct the user interface to display the selected automation information.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 is a block diagram illustrating an industrial environment.

FIG. 2 is a block diagram illustrating an HMI system.

FIG. 3 is a flow diagram illustrating a method of operating an industrial environment.

FIG. 4 is a display diagram illustrating an HMI system display.

FIG. 5 is a display diagram illustrating an HMI system display.

FIG. 6 is a display diagram illustrating an HMI system display.

FIG. 7 is a display diagram illustrating an HMI system display.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Described herein is a system and method for navigating various displays in a Human-Machine Interface (HMI) system. An HMI system can receive status information from machines or processes in an industrial environment and display the raw information, or display that information in a graphical form. Many operators, managers, and other workers who interact with machinery using an HMI system desire to easily and conveniently navigate the display of information.

Examples of possible information a user of an HMI system may view include maintenance, performance, or historical information, operating status of a machine or process, geographic location of a machine, or a list of other machines connected to a machine. In addition, an HMI system may display operation code used to operate a machine, which may then be edited to allow modification of a machine's operation.

In order to easily navigate an HMI system and quickly display the above types of information, a user could, for example, utilize an HMI system incorporating a multi-touch screen capable of receiving multiple simultaneous touches from the user. The user could provide multiple touches on the surface of the touch screen, corresponding to selections of different machines and types of information. The HMI system could then process the touches to provide the requested automation information associated with the machines and types of information selected. The HMI system could then display the requested automation information requested by the user's touches.

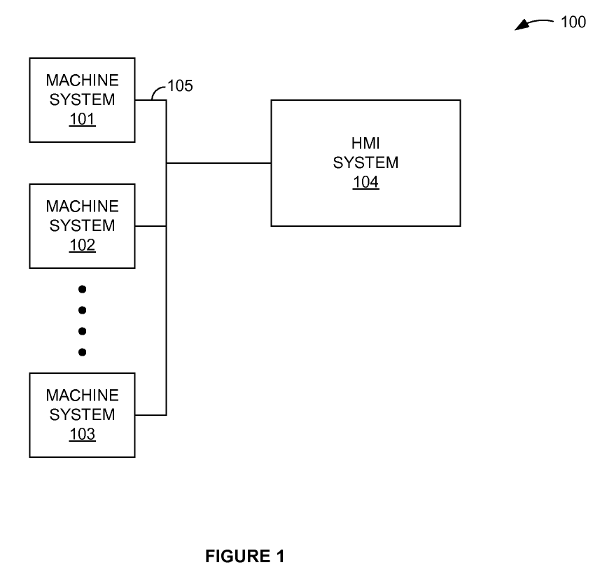

FIG. 1 is a block diagram illustrating industrial environment 100. Industrial environment 100 comprises machine systems 101-103, Human-Machine Interface (HMI) system 104, and communication system 105. The number of machine systems and HMI systems shown in FIG. 1 have been restricted for clarity, but there would typically be many more. Machine systems 10′-103 and HMI system 104 communicate over communication system 105.

Industrial environment 100 includes machine systems 101-103, HMI system 104, and communication system 105. Industrial environment 100 comprises an automobile manufacturing factory, food processing plant, microprocessor fabrication facility, or some other type of industrial enterprise. Machine systems 101-103 comprise pumps, motors, robots, or some other mechanical apparatus, including their associated control systems. A control system comprises, for example, a programmable logic controller (PLC). Additionally, machine systems 101-103 comprise other, non-mechanical elements, such as a brew kettle in a brewery, a reserve of coal or other resources, or any other element that may reside in an industrial environment 100.

Machine systems 101-103 continually produce status data over time. The status data indicates the current status of machine systems 101-103, such as pressure, temperature, speed, or some other status metric. The status data may comprise dynamic charts, real-time video, or some other graphical content. Machine systems 101-103 continually transfer the status data to HMI system 104 over communication system 105. Communication system 105 could be a local area network, wide area network, or some other communication network—including combinations thereof.

HMI system 104 comprises computer and communication equipment and software. HMI system 104 continually receives the status data from machine systems 101-103. HMI system 104 processes the status data to generate various graphical displays indicating the current and historical status of machine systems 101-103. HMI system 104 also controls machine systems 101-103. For example, HMI system 104 might turn on a pump, speed-up a motor, stop a robot, boil a brew kettle, or perform some other type of machine control. Then, an HMI graphical display might indicate the pressure of the pump, the speed of the motor, the output of the robot, the temperature of the brew kettle, or some other status metric. An example of an HMI system that could be adapted in accord with this description is PanelView Plus™ supplied by Rockwell Automation. Other HMI systems are possible.

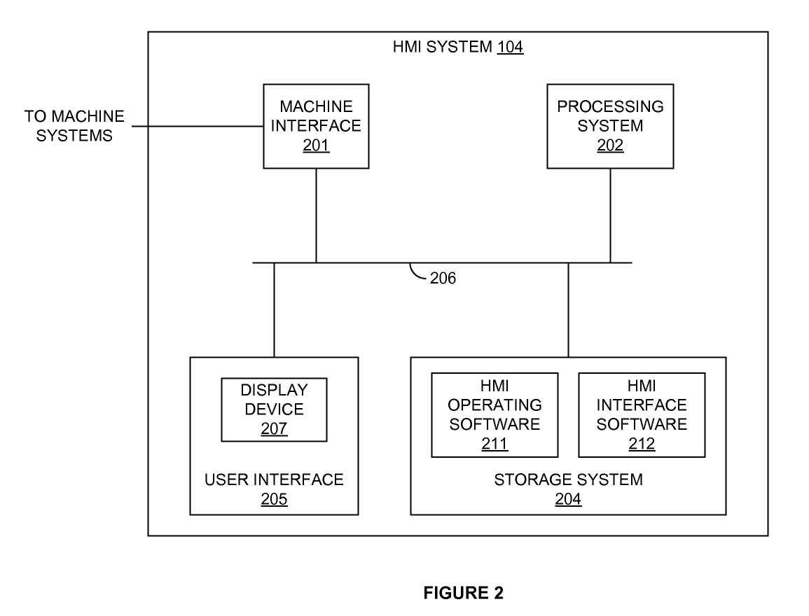

FIG. 2 is a block diagram illustrating HMI system 104. HMI system 104 comprises machine interface 201, processing system 202, storage system 204, user interface 205, and communication system 206. User interface 205 includes display device 207. Storage system 204 stores HMI operating software 211 and HMI interface software 212.

Machine interface 201 comprises communication circuitry and equipment that communicates with machine systems 101-103 over communication system 105. Processing system 202 comprises microprocessors or other logic circuitry that retrieves and executes HMI operating software 211.

User interface 205 comprises a touch screen, a touch pad, or some other user device. Display device 207 comprises a touch screen, liquid crystal display, cathode ray tube display, or some other graphical display mechanism. It should be understood that user interface 205 and display device 207 could comprise a single element providing for all user interaction, such as a touch screen. Additionally or alternatively, user interface 205 could comprise multiple user devices and multiple display devices, including a plurality of touch screens.

Storage system 204 comprises a disk, integrated circuit, flash drive, optical media, or some other memory device. Communication system 206 comprises a bus, local area network, or some other communication apparatus. The above-described components (201-207) of HMI system 104 may be integrated together or distributed among multiple devices.

HMI software 211-212 comprises an application program, firmware, or some other form of machine-readable processing instructions. HMI operating software 211 may include an operating system, utilities, drivers, networking, and applications. When executed by processing system 202, HMI software 211-212 directs HMI system 104 to operate as described herein. HMI interface software 211 comprises an application. An example of HMI interface software is RSView® supplied by Rockwell Automation. Other HMI interface software is possible.

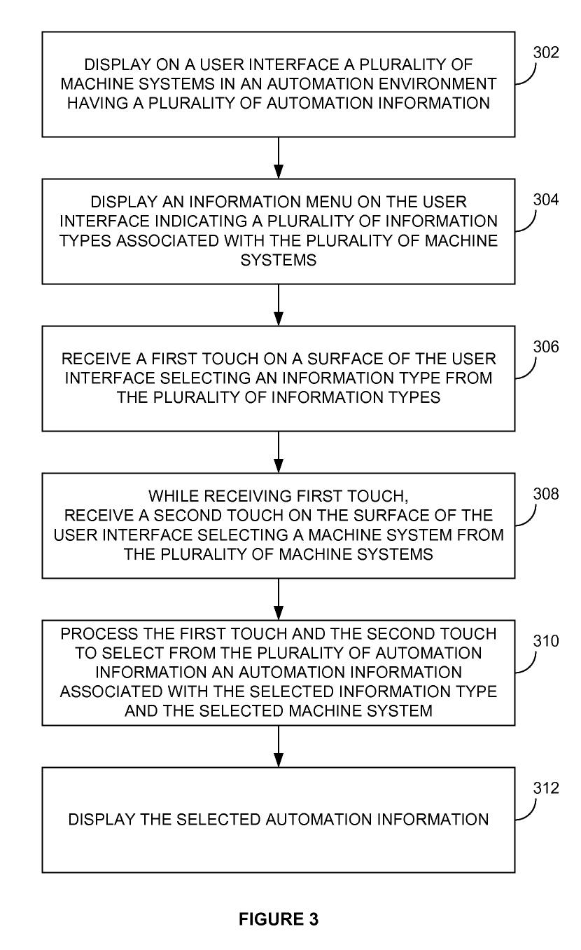

FIG. 3 is a flow diagram illustrating a method of operating industrial environment 100. HMI system 104 displays on a user interface a plurality of machine systems in an automation environment having a plurality of automation information (operation 302). The machine systems referred to in operation 302 could be machine systems 101-103, which could comprise pumps, motors, robots, vats, resources, or any other element residing in industrial environment 100.

HMI system 104 displays an information menu on the user interface indicating a plurality of information types associated with the plurality of machine systems (operation 304). The different information types displayed on the information menu could be, for example, maintenance information, performance information, historical information, operation code from a control system, a geographic location of a machine system, a list of other machine systems connected to a machine system, a ladder diagram, the operating status of a machine system, status metrics, or graphical depictions of status metrics—including combinations thereof.

HMI system 104 receives a first touch on a surface of the user interface selecting an information type from the plurality of information types (operation 306). In one embodiment, more than a single information type is selected.

While receiving the first touch, HMI system 104 receives a second touch on the surface of the user interface selecting a machine system from the plurality of machine systems (operation 308). In one embodiment, more than a single machine system is selected.

In response to the user selections, HMI system 104 processes the first touch and the second touch to select from the plurality of automation information an automation information associated with the selected information type and the selected machine system (operation 310). The automation information selected in operation 310 comprises specific information associated with the machine system selected in operation 308 of the information type selected in operation 306. Based on the automation information selected in operation 310, HMI system 104 displays the selected automation information to the user (operation 312).

A user may select multiple machine systems and multiple information types when navigating user interface 205 of HMI system 104. In addition, a user may select a machine system and an information type in any order, or simultaneously. In one embodiment, a user selects a machine system with a first touch, and an information type with a second touch.

Additionally, in one embodiment, HMI system 104 displays the requested automation information on a second display. In this manner, a user may view the requested automation information on the second display, while continuing to view the many machine systems and information types depicted on the first display.

It should be noted that HMI system 104 may be operated by multiple users simultaneously. In one embodiment, the first touch is provided by a first user, and the second touch is provided by a second user. In another embodiment, multiple users operate HMI system 104 by simultaneously providing distinct sets of a first and second touch. Accordingly, any reference to a singular user hereinabove or hereinafter comprises a single user or a plurality of users.

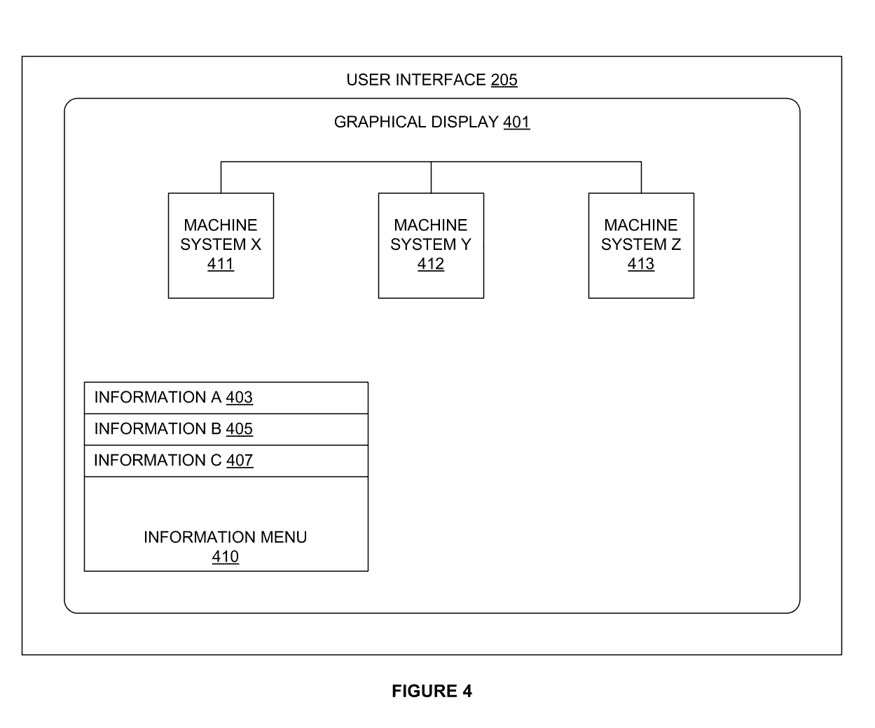

FIG. 4 is a display diagram illustrating an HMI system 104 graphical display 401 provided by user interface 205. Graphical display 401 depicts a plurality of machine systems 411-413 and an information menu 410. Information menu 410 comprises information types 403-407. Note that information menu 410 may display more or fewer information types than the three information types depicted in FIG. 4. Also note that graphical display 401 may display more or fewer machine systems than the three machine systems depicted in FIG. 4.

Machine systems 411-413 are graphical representations of machine systems 101-103 of FIG. 1. Machine systems 411-413 could represent machine systems comprising pumps, motors, robots, vats, resources, or any other element residing in industrial environment 100, including their associated control systems.

Information types 403-407 comprise any type of information associated with a machine system. Examples of possible information types include maintenance, performance, or historical information, operating status of a machine or process, geographic location of a machine, or a list of other machines connected to a machine. In addition, HMI system 104 may display operation code used to operate a machine, which may then be edited to allow modification of a machine's operation.

The user selects at least one information type from the information menu and at least one machine system. In one embodiment, user interface 205 comprises a touch screen and the user selects a machine system and an information type by providing multiple touches on user interface 205. In response to the user selections, HMI system 104 processes the user inputs to select automation information associated with the selected information type and the selected machine system, and then displays the selected automation information on user interface 205.

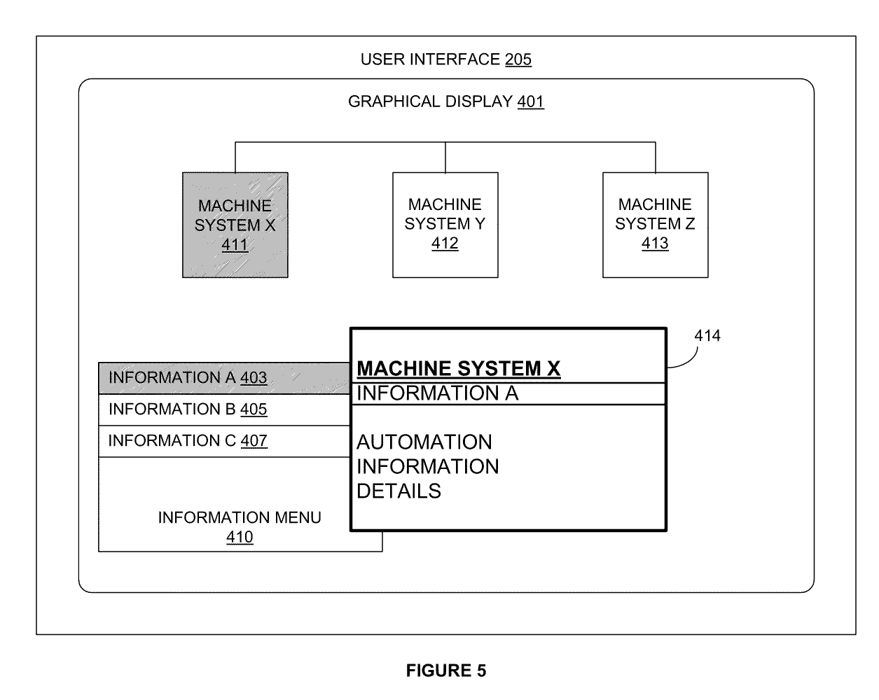

FIG. 5 is a display diagram illustrating an HMI system 104 graphical display 401 provided by user interface 205. In this embodiment, to instruct HMI system 104 to display automation information, a user has selected machine system X 411 and information type A 403. The user selections are depicted in FIG. 5 by the gray shading of machine system X 411 and information A 403. In one embodiment, user interface 205 comprises a touch screen, and the user has made the selections by providing multiple touches on the surface of user interface 205. The user may have touched machine system X 411 first, and then touched information type A 403 second while still touching machine system X 411. In another embodiment, the user touches machine system X 411 and information type A 403 in the opposite order. In yet another embodiment, the user touches machine system X 411 and information type A 403 simultaneously.

HMI system 104 processes the first touch and the second touch to select the automation information associated with the selected information type and the selected machine system. In this embodiment, the user has requested automation information associated with information type A 403 and machine system X 411. In response, HMI system 104 displays the requested automation information in window 414. Note that window 414 informs the user that machine system X has been selected, and information type A is presently displayed.

In one embodiment, window 414 comprises a pop-up window displayed in the foreground, overlaying information menu 410 and machine systems 411-413. Advantageously, after the user releases the touches, window 414 will disappear, allowing the user to view information menu 410 and machine systems 411-413 unimpeded. In another embodiment, window 414 is displayed on a second display device so that the user can fully view information menu 410 and machine systems 411-413.

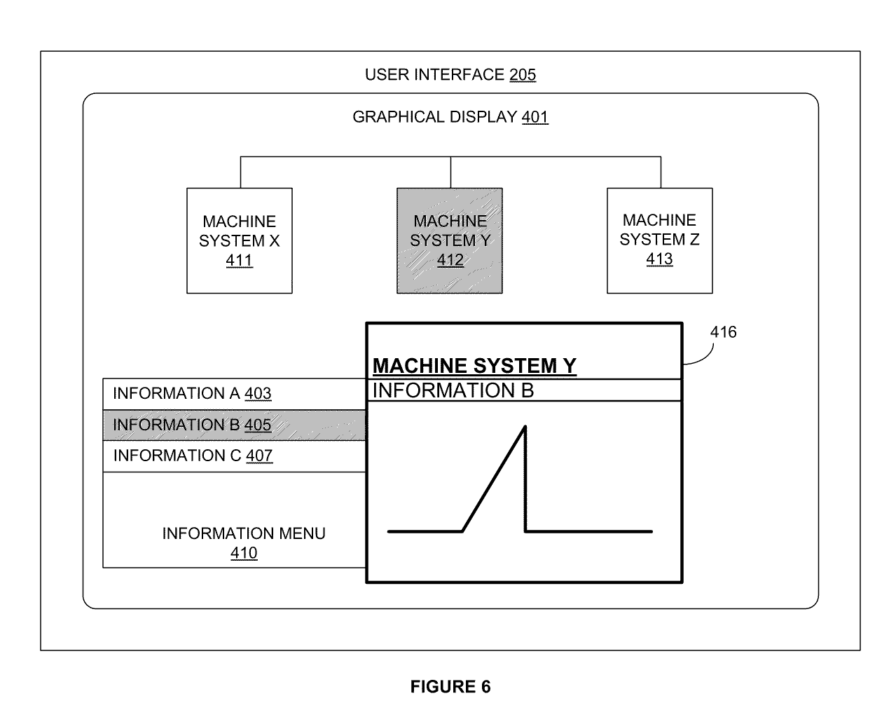

FIG. 6 is a display diagram illustrating an HMI system 104 graphical display 401 provided by user interface 205. In this embodiment, to instruct HMI system 104 to display automation information, a user has selected machine system Y 412 and information type B 405. The user selections are depicted in FIG. 6 by the gray shading of machine system Y 412 and information B 405. In one embodiment, user interface 205 comprises a touch screen, and the user has made the selections by providing multiple touches on the surface of user interface 205. The user may have touched machine system Y 412 first, and then touched information type B 405 second while still touching machine system Y 412. In another embodiment, the user touches machine system Y 412 and information type B 405 in the opposite order. In yet another embodiment, the user touches machine system Y 412 and information type B 405 simultaneously.

HMI system 104 processes the first touch and the second touch to select the automation information associated with the selected information type and the selected machine system. In this embodiment, the user has requested automation information associated with information type B 405 and machine system Y 412. In response, HMI system 104 displays the requested automation information in window 416. Note that window 416 informs the user that machine system Y has been selected, and information type B is presently displayed. Also note that the detailed automation information being displayed in window 416 comprises a graphical representation of the data.

In one embodiment, window 416 comprises a pop-up window displayed in the foreground, overlaying information menu 410 and machine systems 411-413. Advantageously, after the user releases the touches, window 416 will disappear, allowing the user to view information menu 410 and machine systems 411-413 unimpeded. In another embodiment, window 416 is displayed on a second display device so that the user can fully view information menu 410 and machine systems 411-413.

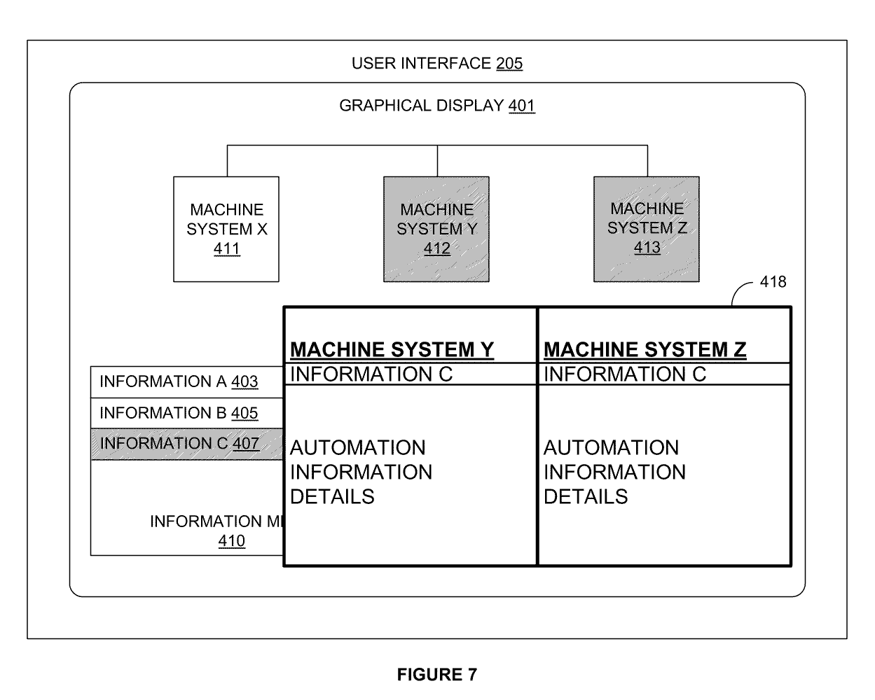

FIG. 7 is a display diagram illustrating an HMI system 104 graphical display 401 provided by user interface 205. In this embodiment, to instruct HMI system 104 to display automation information, a user has selected machine systems Y 412 and Z 413, and information type C 407. The user selections are depicted in FIG. 7 by the gray shading of machine systems Y 412 and Z 413 and information C 407. In one embodiment, user interface 205 comprises a touch screen, and the user has made the selections by providing multiple touches on the surface of user interface 205. The user may have touched the three selections in any order. For example, the user may have touched machine systems Y 412 and Z 413 first, and then touched information type C 407 second while still touching machine systems Y 412 and Z 413. In another embodiment, the user touches machine systems Y 412 and Z 413 and information type C 407 in the opposite order. In another embodiment, the user touches machine system Y 412 first, information type C 407 second, and finally machine system Z 413 third while continuing to touch machine system Y 412 and information type C 407. In yet another embodiment, the user touches machine system Y 412, machine system Z 413, and information type C 407 simultaneously.

HMI system 104 processes the user's touches to select the automation information associated with the selected information type and the selected machine systems. In this embodiment, the user has requested automation information associated with information type C 407 and machine systems Y 412 and Z 413. In response, HMI system 104 displays the requested automation information in window 418. Note that window 418 informs the user that both machine system Y and machine system Z have been selected, and information type C is presently displayed.

In one embodiment, window 418 comprises a pop-up window displayed in the foreground, overlaying information menu 410 and machine systems 411-413. Advantageously, after the user releases the touches, window 418 will disappear, allowing the user to view information menu 410 and machine systems 411-413 unimpeded. In another embodiment, window 418 is displayed on a second display device so that the user can fully view information menu 410 and machine systems 411-413.

Advantageously, a user is able to easily navigate any HMI system 104 graphical display, such as graphical display 401. HMI system 104 can display various information associated with any machine or element residing in industrial environment 100 of FIG. 1. For example, by using multiple touches on a touch screen, a user may select and display maintenance, performance, or historical information associated with a machine system. In addition, the user may display the operation code that provides instructions to a control system for controlling a machine. HMI system 104 may also display the operation code as a ladder diagram. The user may edit the operation code to modify the behavior of a machine system during the course of production.

In another example, the user may select and display on graphical display 401 the operating status of a machine system. For example, the user may display status information associated with a machine system, such as currently on or off, or a rate of speed at which a machine system is operating. In yet another example, the user may determine the geographic location of a machine system. In addition, the user may request a list of other machine systems connected to a selected machine system. For example, in FIG. 7, machine systems Y 412 and Z 413 are connected to machine system X 411.

The above description and associated drawings teach the best mode of the invention. The following claims specify the scope of the invention. Some aspects of the best mode may not fall within the scope of the invention as specified by the claims. Also, while the preceding discussion describes embodiments employed specifically in conjunction with the monitoring and analysis of industrial processes, other applications, such as the mathematical modeling or monitoring of any man-made or naturally-existing system, may benefit from use of the concepts discussed above. Further, those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a Human-Machine Interface (HMI) system, the method comprising:
displaying on a user interface a plurality of machine systems in an automation environment having a plurality of automation information;
displaying an information menu on the user interface indicating a plurality of information types associated with the plurality of machine systems;
receiving a first touch on a surface of the user interface selecting an information type from the plurality of information types;
while receiving the first touch, receiving a second touch on the surface of the user interface selecting a machine system from the plurality of machine systems;
processing the first touch and the second touch to select from the plurality of automation information an automation information associated with the selected information type and the selected machine system; and
displaying the selected automation information.

2. The method of claim 1 wherein the plurality of machine systems comprise at least one machine and at least one control system configured to control the at least one machine.

3. The method of claim 2 wherein the at least one control system includes operation code to operate the at least one machine.

4. The method of claim 1 wherein the information type comprises maintenance information.

5. The method of claim 1 wherein the information type comprises performance information.

6. The method of claim 1 wherein the information type comprises historical information.

7. The method of claim 1 wherein the information type comprises an operating status associated with the selected machine system.

8. The method of claim 1 wherein the information type comprises a geographic location associated with the selected machine system.

9. The method of claim 1 wherein the information type comprises other machine systems connected to the selected machine system.

10. A Human-Machine Interface (HMI) system comprising:
a user interface configured to display a plurality of machine systems in an automation environment having a plurality of automation information, display an information menu indicating a plurality of information types associated with the plurality of machine systems, receive a first touch on a surface of the user interface selecting an information type from the plurality of information types, and, while receiving the first touch, receive a second touch on the surface of the user interface selecting a machine system from the plurality of machine systems;
a processing system configured to process the first touch and the second touch to select from the plurality of automation information an automation information associated with the selected information type and the selected machine system; and
the user interface configured to display the selected automation information.

11. The system of claim 10 wherein the plurality of machine systems comprise at least one machine and at least one control system configured to control the at least one machine.

12. The system of claim 11 wherein the at least one control system includes operation code to operate the at least one machine.

13. The system of claim 10 wherein the information type comprises maintenance information.

14. The system of claim 10 wherein the information type comprises performance information.

15. The system of claim 10 wherein the information type comprises historical information.

16. The system of claim 10 wherein the information type comprises an operating status associated with the selected machine system.

17. The system of claim 10 wherein the information type comprises a geographic location associated with the selected machine system.

18. The system of claim 10 wherein the information type comprises other machine systems connected to the selected machine system.

19. A software product configured to operate a Human-Machine Interface (HMI) system, the software product comprising:
HMI interface software configured to direct a user interface to display a plurality of machine systems in an automation environment having a plurality of automation information, display an information menu indicating a plurality of information types associated with the plurality of machine systems, receive a first touch on a surface of the user interface selecting an information type from the plurality of information types, and, while receiving the first touch, receive a second touch on the surface of the user interface selecting a machine system from the plurality of machine systems;
HMI operation software configured to direct a processing system to process the first touch and the second touch to select from the plurality of automation information an automation information associated with the selected information type and the selected machine system;
the HMI interface software configured to direct the user interface to display the selected automation information; and
a storage system that stores the HMI operation software and the HMI interface software.
